(19) United States
(12) Patent Application Publication
(10) Pub. No.: US 2014/0347397 A1
(43) Pub. Date: Nov. 27, 2014

(54) METHOD AND SYSTEM FOR ADJUSTING SCREEN ORIENTATION OF A MOBILE DEVICE

(71) Applicant: NVIDIA CORPORATION, Santa Clara, CA (US)

(72) Inventor: Hao WU, Shanghai (CN)

(73) Assignee: NVIDIA CORPORATION, Santa Clara, CA (US)

(21) Appl. No.: 14/152,589

(22) Filed: Jan. 10, 2014

(30) Foreign Application Priority Data
May 22, 2013 (CN) 201310193201.3

(51) Int. Cl. G09G 5/32; G06F 3/01

(52) U.S. Cl. CPC G09G 5/32; G06F 3/013
USPC 345/650

(57) ABSTRACT

A method and system for adjusting a screen orientation of a mobile device is provided in the embodiments of the present invention. The method includes obtaining a face image of a user. The method includes extracting location information of two eyes from the face image. The method includes determining a direction vector of a face in the face image according to the location information of the two eyes in the face image. The method includes determining a location relationship between the direction vector and the mobile device in a plane in which a screen of the mobile device is located. Finally, the method includes adjusting the screen orientation of the mobile device according to the location relationship. The embodiments of the present invention provide a technique for making the screen orientation of the mobile device suitable for the user to watch.

### CROSS-REFERENCE TO RELATED APPLICATIONS

This application claims priority to Chinese Patent Application No. 201310193201.3, filed on May 22, 2013, which is hereby incorporated herein by reference.

### FIELD OF INVENTION

Embodiments of the present invention relate generally to mobile devices, and more particularly to a method and system for adjusting screen orientation of a mobile device.

### BACKGROUND

Many mobile devices, such as smartphones and tablets, have an automatic screen rotating system, which is based on a gravity sensor. A mobile device's displayed image rotates automatically at the same time when its body rotates. At some times, when a user lies down and holds the mobile device in hand, they want the displayed image not to rotate but to stay in the original direction adaptive to the user's reading. For this purpose, users need to manually disable the automatic screen rotating system to lock the screen orientation.

### SUMMARY OF THE INVENTION

Accordingly, there is a need for providing a technique to address the problem of improper rotation of a displayed image.

In one embodiment, a method for adjusting a screen orientation of a mobile device is disclosed. The method comprises obtaining a face image of a user. The method also comprises extracting location information of two eyes from the face image. The method also comprises determining a direction vector of a face in the face image according to the location information of the two eyes in the face image. The method also comprises determining a location relationship between the direction vector and the mobile device in a plane in which a screen of the mobile device is located. Finally, the method comprises adjusting the screen orientation of the mobile device according to the location relationship.

Preferably, the method further includes establishing a plane-coordinate system in the plane in which the screen of the mobile device is located before determining the location relationship.

Preferably, the direction vector is from a nose and/or a mouth in the face image to a midpoint of a central connecting line of the two eyes in the face image along a central line of the face in the face image.

Preferably, the determining the direction vector includes the following steps. The central connecting line of the two eyes in the face image is determined according to the location information of the two eyes in the face image. Location information of the nose and/or the mouth is extracted from the face image. The direction vector is determined according to the central connecting line of the two eyes and the location information of the nose and/or the mouth in the face image.

Preferably, the x-axis of the plane-coordinate system is parallel to a top surface of the mobile device and points to a right side of the screen and the y-axis of the plane-coordinate system is perpendicular to the top surface and points to a top of the screen. The location relationship is represented by an angle α from the y-axis to the direction vector. The adjusting the screen orientation includes: in case of 0°≦α<45° and 315°≦α<360°, adjusting the screen orientation to be a positive portrait orientation; in case of 45°≦α<135°, adjusting the screen orientation to be a left landscape orientation; in case of 135°≦α<225°, adjusting the screen orientation to be an inverted portrait orientation; and in case of 225°≦α<315°, adjusting the screen orientation to be a right landscape orientation.

Preferably, the method further includes: before establishing the plane-coordinate system, obtaining an initial face image when the mobile device is parallel to a face of the user and in a positive portrait mode; extracting initial location information of two eyes from the initial face image; and determining an initial direction vector of a face in the initial face image according to the initial location information. The determining the location relationship is based on the initial direction vector.

Preferably, the initial direction vector is from a mouth in the initial face image to a midpoint of a central connecting line of the two eyes in the initial face image along a central line of the face in the initial face image.

Preferably, the x-axis of the plane-coordinate system is perpendicular to the initial direction vector and points to a right side of the face in the initial face image. The direction of the y-axis of the plane-coordinate system is the same as the direction of the initial direction vector. The location relationship is represented by an angle α from the y-axis to the direction vector. The adjusting the screen orientation includes: in case of 0°≦α<45° and 315°≦α<360°, adjusting the screen orientation to be a positive portrait orientation; in case of 45°≦α<135°, adjusting the screen orientation to be a left landscape orientation; in case of 135°≦α<225°, adjusting the screen orientation to be an inverted portrait orientation; and in case of 225°≦α<315°, adjusting the screen orientation to be a right landscape orientation.

Preferably, the method further includes inquiring the user whether to adjust the screen orientation before the adjusting. The adjusting the screen orientation is performed according to an instruction of the inquired user.

Preferably, the adjusting the screen orientation is performed after a predetermined period of time after determining the location relationship.

Preferably, the method further includes detecting a location of the mobile device before obtaining the face image. The obtaining the face image may be performed only if a change of the location of the mobile device is detected.

Preferably, the obtaining the face image is performed after a predetermined period of time after the change of the location of the mobile device is detected.

Preferably, the detecting the location of the mobile device is performed by a gyroscope of the mobile device.

Preferably, the obtaining the face image is performed by a camera of the mobile device.

In another embodiment, a system for adjusting a screen orientation of a mobile device is presented. The system comprises an image obtaining module for obtaining a face image of a user. The system also comprises a location extracting module for extracting location information of two eyes from the face image. The system also comprises a direction determining module for determining a direction vector of a face in the face image according to the location information of the two eyes in the face image. The system also comprises a relationship determining module for determining a location relationship between the direction vector and the mobile device in a plane in which a screen of the mobile device is located. Finally, the system comprises a display adjusting module for adjusting the screen orientation of the mobile device according to the location relationship.

Preferably, the system further includes a plane-coordinate system establishing module for establishing a plane-coordinate system in the plane in which the screen of the mobile device is located before determining the location relationship.

Preferably, the system further includes an interaction module for inquiring the user whether to adjust the screen orientation before the adjusting by the display adjusting module. The display adjusting module is further operable to adjust the screen orientation according to an instruction of the inquired user.

Preferably, the display adjusting module is further operable to adjust the screen orientation after a predetermined period of time after the location relationship is determined by the relationship determining module.

Preferably, the system further includes a location detecting module for detecting a location of the mobile device before the face image is obtained by the image obtaining module. The image obtaining module may be further operable to obtain the face image only if a change of the location of the mobile device is detected by the location detecting module.

Preferably, the image obtaining module is further operable to obtain the face image after a predetermined period of time after the change of the location of the mobile device is detected by the location detecting module.

Embodiments of the present invention provide a technique for making the screen orientation of the mobile device suitable for users to watch.

Advantages and features of the embodiments of the present invention will be described in detail below in connection with the accompanying drawings.

### BRIEF DESCRIPTION OF THE DRAWINGS

In order that the advantages of the invention will be readily understood, a more detailed description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 illustrates a flow chart of a method for adjusting a screen orientation of a mobile device, according to an embodiment of the present invention;

FIG. 2A illustrates a schematic diagram of a face image, according to an embodiment of the present invention;

FIG. 2B illustrates a schematic diagram of a face image in which a direction vector is shown, according to another embodiment of the present invention;

FIG. 3 illustrates a flow chart of a method for determining a direction vector, according to an embodiment of the present invention;

FIG. 4 illustrates a schematic diagram of a mobile device in which a plane-coordinate system is shown, according to an embodiment of the present invention; and

FIG. 5 illustrates a schematic block diagram of a system for adjusting a screen orientation of a mobile device, according to an embodiment of the present invention.

### DETAILED DESCRIPTION

In the following discussion, details are presented so as to provide a more thorough understanding of the present invention. However, the present invention may be implemented without one or more of these details as would be apparent to one of ordinary skill in the art. Certain examples are illustrated without elaborate discussion of technical features that would be within the purview of one of ordinary skill in the art so as to avoid confusion with the present invention.

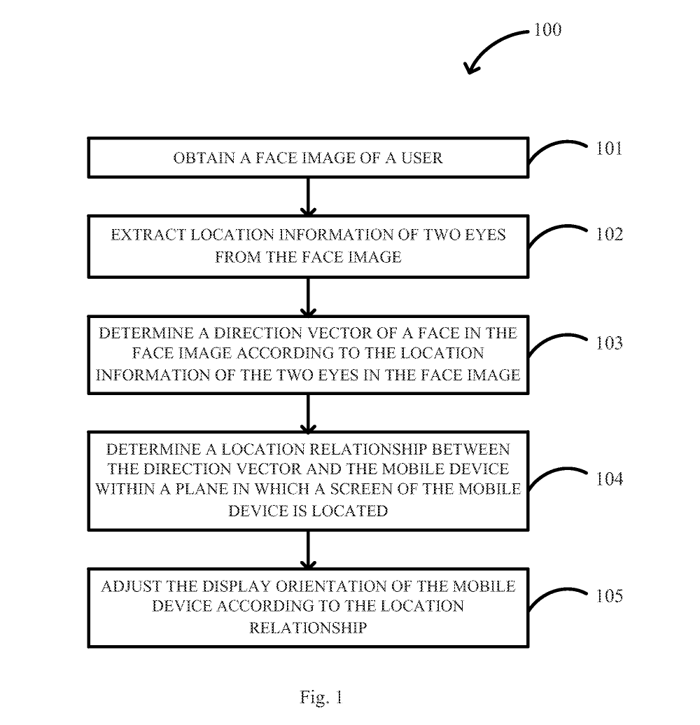

In an embodiment, a method for adjusting a screen orientation of a mobile device is disclosed. The mobile device may be a device such as a smartphone or a tablet, etc. Now the method of the present invention will be described in detail in combination with FIG. 1-4.

FIG. 1 illustrates a flow chart of a method 100 for adjusting a screen orientation of a mobile device, according to an embodiment of the present invention.

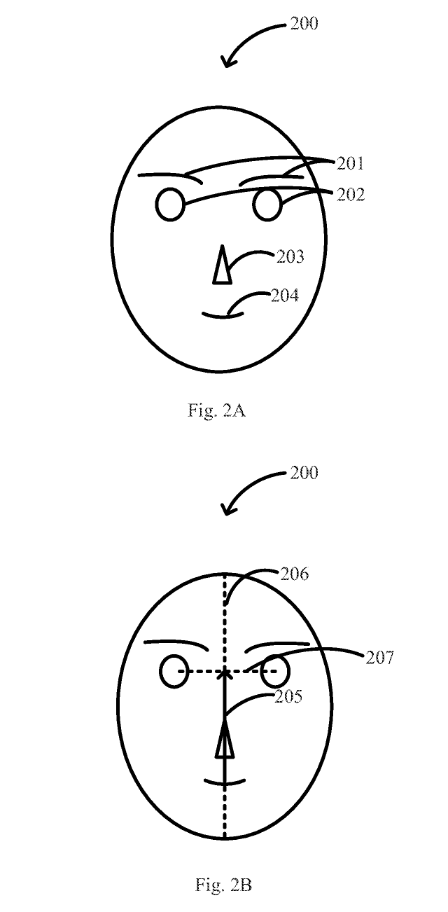

As shown in FIG. 1, the method 100 begins at step 101. At step 101, a face image of a user is obtained. FIG. 2A illustrates a schematic diagram of a face image 200, according to an embodiment of the present invention. The face image 200 may include information about the user's two eyebrows 201, two eyes 202, a nose 203 and a mouth 204, etc. A face may be shot by a camera of the mobile device to obtain a face image. For example, a face may be shot by a front-facing camera of a smart phone. In one embodiment, the camera is integrated in the mobile device. Integration of the camera in the mobile device is convenient for the user to use and carry. In another embodiment, the camera, independent of the mobile device, communicates with the mobile device through, for example a universal serial bus (USB). An individual camera allows maintenance and replacement thereof to be simpler. The camera may include a lens, an image sensor and a digital signal processor (DSP), etc. The lens may project light reflected from the face onto a surface of the image sensor. The image sensor may convert optical signals into electrical signals, and then convert the electrical signals into digital image signals after analog-to-digital (A/D) conversion. Then the image sensor may transmit the digital image signals to the DSP. The DSP may process the digital image signals and output image data in YUV or RGB format. The DSP transmits the image data to a central processing unit (CPU) and/or a graphics processing unit (GPU) of the mobile device via a data bus of the mobile device for further processing. The CPU and/or the GPU utilize the image data to generate the face image. The face image may or may not be displayed on a display screen of the mobile device. At step 102, location information of the two eyes 202 is extracted from the face image 200. The gray value of two eyes is usually less than that of their surrounding areas in the face image, thus the location information of the two eyes 202 may be extracted by using an integral projection method. Specifically, at first, an approximate region of the two eyes is roughly estimated according to the facial proportions of the face and identified. The approximate region is referred to as a “window”. A characteristic of the face is that pupils and eyebrows of the face are the blackest in the window. Then according to the above characteristic, the image in the window is analyzed using a histogram thereof and the blackest region is separated from the image using a threshold. Finally, a horizontal gray projection and a vertical gray projection of the image in the blackest region are performed to determine the location of pupils of the two eyes 202, which represents the location information of the two eyes 202.

At step 103, a direction vector of a face in the face image 200 is determined according to the location information of the two eyes 202 in the face image 200. The direction vector may represent the direction of the face in a plane in which the face image 200 is located. The face in the face image 200 rotates as a real face rotates relative to the mobile device, thus the direction vector changes. FIG. 2B illustrates a schematic diagram of a face image 200 in which a direction vector 205 is shown, according to another embodiment of the present invention.

The direction vector 205 may be from the nose 203 and/or the mouth 204 in the face image 200 to a midpoint of a central connecting line 207 of the two eyes 202 in the face image 200 along a central line 206 of the face in the face image 200. The central connecting line 207 refers to a line segment connecting two centers of the two eyes 202. The magnitude of the direction vector may be arbitrary. Although the direction vector is described in combination with the accompanying drawings herein, those skilled in the art will understand that the description is only illustrative and the direction vector may have any other direction and magnitude.

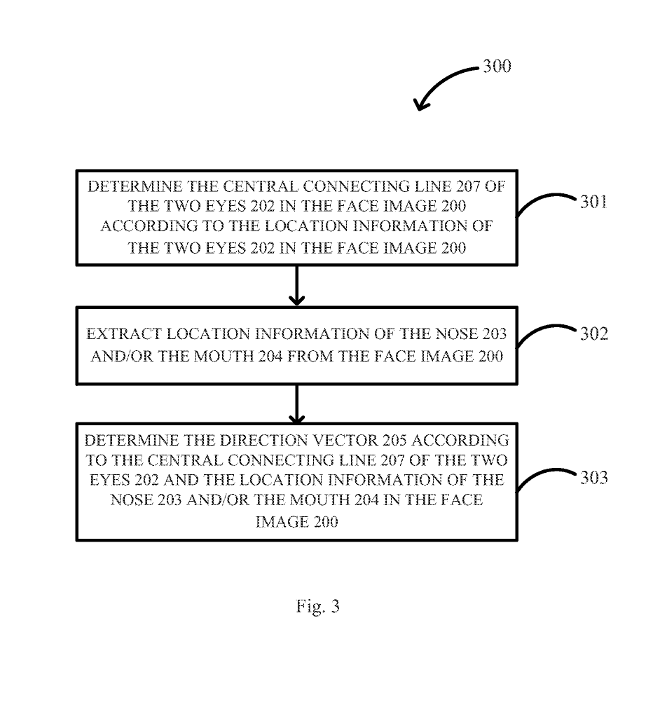

The direction vector 205 may be determined based on the nose 203 and/or the mouth 204 and the two eyes 202 and/or the two eyebrows 201. Preferably, the direction vector 205 is determined based on the nose 203 and/or a mouth 204 and the two eyes 202. Now method steps for determining the direction vector 205 will be described in combination with FIG. 2B and FIG. 3. FIG. 3 illustrates a flow chart of a method 300 for determining the direction vector 205, according to an embodiment of the present invention. The method 300 for determining the direction vector 205 includes the following steps. At step 301, the central connecting line 207 of the two eyes 202 in the face image 200 is determined according to the location information of the two eyes 202 in the face image 200. In the step 103 of the method 100, the location information of the two eyes 202, for example locations of the pupils may be obtained. The pupils of the two eyes 202 may be connected to obtain the central connecting line 207. At step 302, location information of the nose 203 and/or the mouth 204 are extracted from the face image 200. The method for extracting the location information of the nose 203 or the mouth 204 is similar to that used in extracting the location information of the two eyes 202. Those skilled in the art can understand the method for extracting the location information of the nose 203 or the mouth 204 in light of the teachings and guidance presented herein, so a detailed description thereof is omitted. At step 303, the direction vector 205 is determined according to the central connecting line 207 of the two eyes 202 and the location information of the nose 203 and/or the mouth 204 in the face image 200. The two eyes, the nose and the mouth are obvious facial features of the face and their locations are easy to be recognized, thus determining the direction vector according to the two eyes and the nose and/or the mouth is relatively simple and easy to achieve.

Referring back to FIG. 1, at step 104, a location relationship between the direction vector and the mobile device in a plane in which a screen of the mobile device is located is determined. In one embodiment, the location relationship between the direction vector and the mobile device may represent a location relationship between the face and the mobile device.

At step 105, the screen orientation of the mobile device is adjusted according to the location relationship. The screen orientation may be arbitrary orientation, including but not limited to a positive portrait orientation, a left landscape orientation, an inverted portrait orientation and a right landscape orientation. The positive portrait orientation refers to an orientation of the displayed image when the top of the displayed image is located at the top of the screen of the mobile device. The left landscape orientation refers to an orientation of the displayed image when the top of the displayed image is located at the left side of the screen of the mobile device. The inverted portrait orientation refers to an orientation of the displayed image when the top of the displayed image is located at the bottom of the screen of the mobile device. The right landscape orientation refers to an orientation of the displayed image when the top of the displayed image is located at the right side of the screen of the mobile device. The deflection angle of the face relative to the mobile device may be determined after determining the location relationship between the direction vector and the mobile device. The screen orientation may be adjusted to an orientation suitable for the user's eyes to watch. For example, when the user changes his state from standing or sitting to lying on his left side, if the relative location of the user and the mobile device remains unchanged, then the screen orientation keeps original orientation without rotating.

Adjusting the screen orientation according to the obtained face image of the user may allow the screen orientation to rotate based on the relative location relationship of the user and the mobile device instead of an absolute motion of the mobile device. Accordingly, the screen orientation may be kept suitable for the user to watch.

Preferably, the method 100 may also include detecting and positioning the face and pre-processing the image before extracting the location information of two eyes. Detecting and positioning the face may include analyzing the face image and separating the face from the background image. Pre-processing the image may include performing normalization, edge detection and noise elimination on the face image to provide conditions for subsequent feature extraction.

Preferably, the method may further include establishing a plane-coordinate system in the plane in which the screen of the mobile device is located before determining the location relationship. Establishing a plane-coordinate system is conducive to the determination of the location relationship by a processor of the mobile device, which may simplify the algorithms involved in the process of determining the location relationship. The plane-coordinate system is preferably a Cartesian coordinate system.

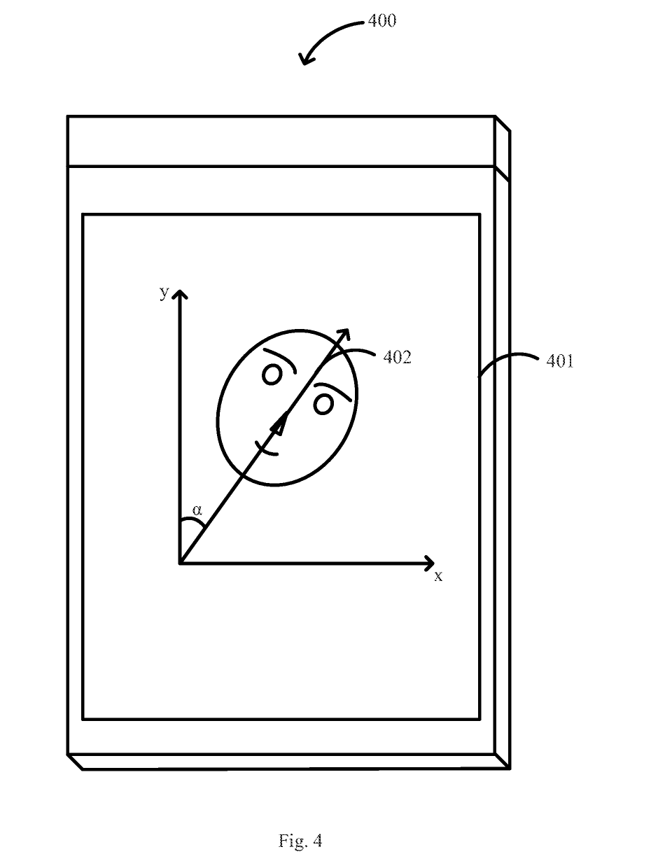

The above plane-coordinate system and location relationship will be described in combination with FIG. 4 below. FIG. 4 illustrates a schematic diagram of a mobile device 400 in which a plane-coordinate system is shown, according to an embodiment of the present invention. The mobile device 400 includes a screen 401.

As shown in FIG. 4, the x-axis of the plane-coordinate system is parallel to a top surface of the mobile device 400 and points to a right side of the screen 401. The top surface of the mobile device 400 refers to a surface of the mobile device 400 which is on the top when the mobile device 400 is normally used in a vertical state. The y-axis of the plane-coordinate system is perpendicular to the top surface and points to a top of the screen 401. The origin of the plane-coordinate system may be arbitrary. The location relationship may be represented by an angle α from the y-axis to the direction vector 402. Adjusting the screen orientation may include the following steps. In case of 0°≦α<45° and 315°≦α<360°, the screen orientation is adjusted to be a positive portrait orientation. In case of 45°≦α<135°, the screen orientation is adjusted to be a left landscape orientation. In case of 135°≦α<225°, the screen orientation is adjusted to be an inverted portrait orientation. In case of 225°≦α<315°, the screen orientation is adjusted to be a right landscape orientation.

In one embodiment, the method 100 may further include the following steps which are performed before establishing the plane-coordinate system. An initial face image when the mobile device is parallel to a face of the user and in a positive portrait mode is obtained. Initial location information of two eyes is extracted from the initial face image. An initial direction vector of a face in the initial face image is determined according to the initial location information. The determining the location relationship is based on the initial direction vector. The method for determining the initial direction vector is similar to the above method for determining the direction vector. Those skilled in the art can understand the method for determining the initial direction vector in light of the teachings and guidance presented herein, such a detailed description thereof is omitted. Determining the location relationship based on the initial direction vector may correctly obtain the location relationship between the face and the mobile device even when the position or the direction of the used camera is unknown. For example, when the face image is obtained using a camera of the mobile device and the camera is inverted, the obtained face image is also inverted. If the mobile device is in positive portrait state while obtaining the face image, then the angle between the initial direction vector and the direction vector is 0. Accordingly, it may be determined that the direction of the mobile device is the same as that of the real face and the screen orientation of the mobile device does not need to rotate. Accordingly, even in a situation where the shooting direction of a camera is not correct, determining the location relationship based on the initial direction vector may ensure that the relative location relationship between the real face and the mobile device is determined correctly.

Alternatively, the initial direction vector is from a mouth in the initial face image to a midpoint of a central connecting line of the two eyes in the initial face image along a central line of the face in the initial face image. The magnitude of the initial direction vector may be arbitrary. Such an initial direction vector may simplify the algorithms used for determining the initial direction vector.

Alternatively, the x-axis of the plane-coordinate system used in the above technical scheme involving the initial direction vector is perpendicular to the initial direction vector and points to a right side of the face in the initial face image. The direction of the y-axis of the plane-coordinate system is the same as the direction of the initial direction vector. The location relationship may be represented by an angle α from the y-axis to the direction vector. The adjusting the screen orientation includes the following steps. In case of 0°≦α<45° and 315°≦α<360°, the screen orientation is adjusted to be a positive portrait orientation. In case of 45°≦α<135°, the screen orientation is adjusted to be a left landscape orientation. In case of 135°≦α<225°, the screen orientation is adjusted to be an inverted portrait orientation. In case of 225°≦α<315°, the screen orientation is adjusted to be a right landscape orientation. The angle from the y-axis to the direction vector represents the angle between the initial direction vector and the direction vector. As such, α represents a deflection angle of the face in the current face image relative to the face in the initial face image. Because the plane-coordinate system is established based on the initial direction vector instead of the mobile device, α may reflect the location relationship between the current real face and the mobile device correctly.

Alternatively, the method 100 may further include inquiring the user whether to adjust the screen orientation before the adjusting and the adjusting the screen orientation is performed according to an instruction of the inquired user. For example, when it is determined that the screen orientation needs to be adjusted to an orientation suitable for the user to watch, a message may be sent to the user via the screen by CPU of the mobile device to inquire the user whether to adjust the screen orientation. If the user selects “YES”, then the screen orientation is adjusted. If the user selects “NO”, then the screen orientation is not adjusted. Adjusting the screen orientation according to the user instruction may satisfy the demands of the user better and further avoid the occurrence of an unnecessary adjustment.

Alternatively, the adjusting the screen orientation is performed after a predetermined period of time after determining the location relationship. A predetermined period of time may be set between the step of determining the location relationship and the step of adjusting the screen orientation. After determining the location relationship, adjusting the screen orientation is not performed immediately but after waiting for the predetermined period of time. Waiting for the predetermined period of time may avoid incorrect operations. The predetermined period of time may be any suitable period of time, such as 3s. For example, when the user drops the mobile device and picks it up quickly, if the time spent by the user is less than the predetermined period of time, then the screen orientation is not adjusted. Thus it may be avoided that the screen orientation is adjusted frequently and energy is wasted.

Alternatively, the method 100 may further include detecting a location of the mobile device before obtaining the face image. The obtaining the face image is performed if a change of the location of the mobile device is detected. The obtaining the face image may be performed in real time or conditionally. The mobile device may keep itself still for a long time in use, thus the relative location relationship between the mobile and the user may also remain unchanged. In other words, if the relative location relationship between the mobile and the user changes, the mobile device is usually moved. So the obtaining the face image may be performed when the location of the mobile device changes is beneficial for saving resources.

Alternatively, the obtaining the face image is performed after a predetermined period of time after the change of the location of the mobile device is detected. After the change of the location of the mobile device is detected, the obtaining the face image is not performed immediately but after waiting for the predetermined period of time. Waiting for the predetermined period of time may avoid incorrect operations. The predetermined period of time may be any suitable period of time, such as 3s. For example, when the user drops the mobile device and picks it up quickly, if the time spent by the user is less than the predetermined period of time, then the face image is not obtained. Thus it may be avoided that the face image is obtained frequently and energy is wasted.

Alternatively, the detecting the location of the mobile device is performed by a gyroscope of the mobile device. The gyroscope may be used to measure a location, movements, and an acceleration of the mobile device in three-dimension space. Using the gyroscope to detect the location of the mobile device may obtain the location information of the mobile device in real time and accurately.

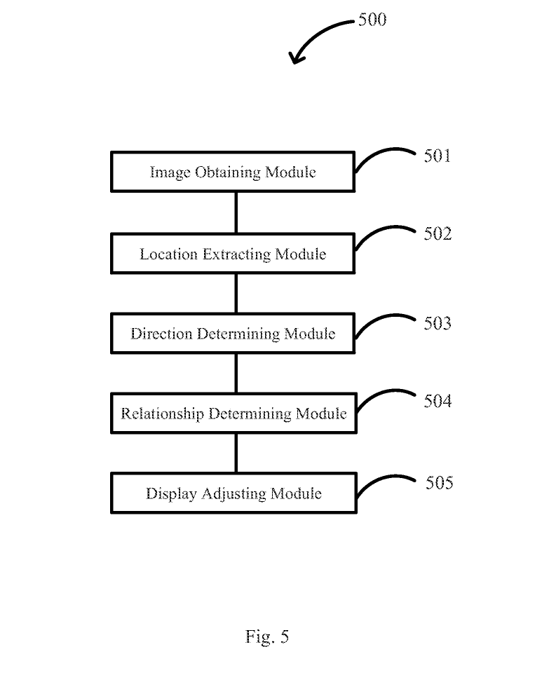

In another aspect, a system for adjusting a screen orientation of a mobile device is also disclosed. FIG. 5 illustrates a schematic block diagram of a system 500 for adjusting a screen orientation of a mobile device, according to an embodiment of the present invention. The system 500 may include an image obtaining module 501 for obtaining a face image of a user. The system 500 may include a location extracting module 502 for extracting location information of two eyes from the face image. The system 500 may include a direction determining module 503 for determining a direction vector of a face in the face image according to the location information of the two eyes in the face image. The system 500 may include a relationship determining module 504 for determining a location relationship between the direction vector and the mobile device in a plane in which a screen of the mobile device is located. The system 500 may include a display adjusting module 505 for adjusting the screen orientation of the mobile device according to the location relationship.

Preferably, the system 500 may further include a plane-coordinate system establishing module for establishing a plane-coordinate system in the plane in which the screen of the mobile device is located before determining the location relationship.

Preferably, the system 500 may further include an interaction module for inquiring the user whether to adjust the screen orientation before the adjusting by the display adjusting module 505. The display adjusting module 505 may be further operable to adjust the screen orientation according to an instruction of the inquired user.

Preferably, the display adjusting module 505 may be further operable to adjust the screen orientation after a predetermined period of time after the location relationship is determined by the relationship determining module 504.

Preferably, the system 500 may further include a location detecting module for detecting a location of the mobile device before the face image is obtained by the image obtaining module 501. The image obtaining module 501 may be further operable to obtain the face image when a change of the location of the mobile device is detected by the location detecting module.

Preferably, the image obtaining module 501 may be further operable to obtain the face image after a predetermined period of time after the change of the location of the mobile device is detected by the location detecting module.

Those skilled in the art can understand the operation mode of the system 500 with reference to FIGS. 1-5 in combination with the above description about embodiments of the method for adjusting a screen orientation of a mobile device. For brevity, a detailed description thereof is omitted.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A method for adjusting a screen orientation of a mobile device, including:
obtaining a face image of a user;
extracting location information of two eyes from the face image;
determining a direction vector of a face in the face image according to the location information of the two eyes in the face image;
determining a location relationship between the direction vector and the mobile device in a plane in which a screen of the mobile device is located; and
adjusting the screen orientation of the mobile device according to the location relationship.

2. The method according to claim 1, wherein the method further includes establishing a plane-coordinate system in the plane in which the screen of the mobile device is located before determining the location relationship.

3. The method according to claim 2, wherein the direction vector is from a nose and/or a mouth in the face image to a midpoint of a central connecting line of the two eyes in the face image along a central line of the face in the face image.

4. The method according to claim 3, wherein the determining the direction vector includes:
determining the central connecting line of the two eyes in the face image according to the location information of the two eyes in the face image;
extracting location information of the nose and/or the mouth from the face image; and
determining the direction vector according to the central connecting line of the two eyes and the location information of the nose and/or the mouth in the face image.

5. The method according to claim 3, wherein the x-axis of the plane-coordinate system is parallel to a top surface of the mobile device and points to a right side of the screen and the y-axis of the plane-coordinate system is perpendicular to the top surface and points to a top of the screen, wherein the location relationship is represented by an angle α from the y-axis to the direction vector, and the adjusting the screen orientation includes:
in case of 0°≦α<45° and 315°≦α<360°, adjusting the screen orientation to be a positive portrait orientation;
in case of 45°≦α<135°, adjusting the screen orientation to be a left landscape orientation;
in case of 135°≦α<225°, adjusting the screen orientation to be an inverted portrait orientation; and
in case of 225°≦α<315°, adjusting the screen orientation to be a right landscape orientation.

6. The method according to claim 3, wherein the method further includes:
before establishing the plane-coordinate system, obtaining an initial face image when the mobile device is parallel to a face of the user and in a positive portrait mode;
extracting initial location information of two eyes from the initial face image; and
determining an initial direction vector of a face in the initial face image according to the initial location information;
wherein the determining the location relationship is based on the initial direction vector.

7. The method according to claim 6, wherein the initial direction vector is from a mouth in the initial face image to a midpoint of a central connecting line of the two eyes in the initial face image along a central line of the face in the initial face image.

8. The method according to claim 7, wherein the x-axis of the plane-coordinate system is perpendicular to the initial direction vector and points to a right side of the face in the initial face image, and wherein the direction of the y-axis of the plane-coordinate system is the same as the direction of the initial direction vector, and wherein the location relationship is represented by an angle α from the y-axis to the direction vector, and wherein the adjusting the screen orientation includes:
in case of 0°≦α<45° and 315°≦α<360°, adjusting the screen orientation to be a positive portrait orientation;
in case of 45°≦α<135°, adjusting the screen orientation to be a left landscape orientation;
in case of 135°≦α<225°, adjusting the screen orientation to be an inverted portrait orientation;
and
in case of 225°≦α<315°, adjusting the screen orientation to be a right landscape orientation.

9. The method according to claim 1, wherein the method further includes inquiring the user whether to adjust the screen orientation before the adjusting, and wherein the adjusting the screen orientation is performed according to an instruction of the inquired user.

10. The method according to claim 1, wherein the adjusting the screen orientation is performed after a predetermined period of time after determining the location relationship.

11. The method according to claim 1, wherein the method further includes:
detecting a location of the mobile device before obtaining the face image;
wherein the obtaining the face image is performed when a change of the location of the mobile device is detected.

12. The method according to claim 11, wherein the obtaining the face image is performed after a predetermined period of time after the change of the location of the mobile device is detected.

13. The method according to claim 11, wherein the detecting the location of the mobile device is performed by a gyroscope of the mobile device.

14. The method according to claim 1, wherein the obtaining the face image is performed by a camera of the mobile device.

15. A system for adjusting a screen orientation of a mobile device, including:
an image obtaining module for obtaining a face image of a user;
a location extracting module for extracting location information of two eyes from the face image;
a direction determining module for determining a direction vector of a face in the face image according to the location information of the two eyes in the face image;
a relationship determining module for determining a location relationship between the direction vector and the mobile device in a plane in which a screen of the mobile device is located; and
a display adjusting module for adjusting the screen orientation of the mobile device according to the location relationship.

16. The system according to claim 15, wherein the system further includes a plane-coordinate system establishing module for establishing a plane-coordinate system in the plane in which the screen of the mobile device is located before determining the location relationship.

17. The system according to claim 15, wherein the system further includes an interaction module for inquiring the user whether to adjust the screen orientation before the adjusting by the display adjusting module, and wherein the display adjusting module is further operable to adjust the screen orientation according to an instruction of the inquired user.

18. The mobile device according to claim 15, wherein the display adjusting module is further operable to adjust the screen orientation after a predetermined period of time after the location relationship is determined by the relationship determining module.

19. The system according to claim 15, wherein the system further includes:
a location detecting module for detecting a location of the mobile device before the face image is obtained by the image obtaining module;
and wherein the image obtaining module is further operable to obtain the face image when a change of the location of the mobile device is detected by the location detecting module.

20. The system according to claim 19, wherein the image obtaining module is further operable to obtain the face image after a predetermined period of time after the change of the location of the mobile device is detected by the location detecting module.
